(19) United States
(12) Patent Application Publication
(10) Pub. No.: US 2024/0160803 A1
(43) Pub. Date: May 16, 2024

(54) CO-SIMULATION OF STEADY STATE AND TRANSIENT BEHAVIORS OF AN ELECTRIC SYSTEM

(71) Applicant: X Development LLC, Mountain View, CA (US)

(72) Inventors: Leo Francis Casey, San Francisco, CA (US); Xinyue Li, San Mateo, CA (US); David Charles Chou, Fremont, CA (US); Mike Miao He, Mountain View, CA (US)

(21) Appl. No.: 17/986,551

(22) Filed: Nov. 14, 2022

(51) Int. Cl. G06F 30/20

(52) U.S. Cl. CPC G06F 30/20; G06F 2113/04

(57) ABSTRACT

Methods, systems, and apparatus, including computer programs encoded on a computer storage medium, for obtaining a model of an electric power grid; simulating first behaviors of a region using a first time resolution and a first modeling domain to determine operational parameters. Determining first values for the operational parameters at a first transition. Converting the first values into a second modeling domain at the first transition time point to obtain converted first values for initial conditions. Simulating second behaviors of the region using a second time resolution and the second modeling domain to determine second operational parameters. Providing, as output, simulation results from at least one of the first behaviors and the second behaviors.

### TECHNICAL FIELD

The present specification relates to electrical power grids, and specifically to performing operational modeling and simulation of an electrical grid system.

### BACKGROUND

Electrical power grids transmit electrical power to loads such as residential and commercial buildings. Virtual models of an electrical grid can be used to simulate operations under various conditions.

### SUMMARY

Techniques are described for simulation of electrical power grid behaviors. In general, the present disclosure relates to a system for accurately simulating operations of electrical power grids. Electrical grid models are used to evaluate and predict operations and potential faults in an electrical grid. Because of the inherent complexity of electric power grids, steady state and transient power grid operations are traditionally molded separately. The present disclosure provides a system and method for integrating simulations of steady state and transient operations which account for the effects of transient events on the steady state operations and vice versa.

The disclosed techniques use fully-integrated, spatially and temporally fine-grained models of the electric power system, along with an adaptable and scalable simulation engine. The virtual electrical grid model can include representations of existing real-world electrical grid components, representations of planned electrical grid components, or a combination of representations of existing and planned electrical grid components.

In some cases, a grid modeling and simulation system may perform a simulation in response to a request for simulation results that is provided through a user interface or an automatically triggered request. The request may be for output that shows the operational impacts of a change to the electrical grid, such as adding or removing an electrical power source or load. In some cases, the request may be for output that shows the operational impact of an event, such as a lightning strike or an outage of a power generating station connected to the electrical grid.

The grid modeling and simulation system can be adaptable in time resolution and time duration. For example, the system allows simulations across all time scales of interest from nanoseconds to years and at various time resolutions. The grid modeling and simulation system can be adaptable in spatial expanse to enable simulations that can be used to evaluate both hyperlocal and system-wide impacts. For example, the system allows simulations across all spatial scales of interest from meters to hundreds of kilometers at various spatial resolutions.

In some implementations, when the system receives a request for simulation results, the system can select a simulation mode based on the type of request. The simulation mode can include a time resolution, a time scale, a spatial resolution, and a spatial scale of the simulation.

In an example scenario, the system may receive a request for simulation results showing real-world electrical impacts of a rapid transient event on loads of an electrical feeder. Based on the request, the system can select whether a transient or steady-state operations would be more appropriate. The chosen simulation mode includes a time resolution, e.g., of nanoseconds, a time scale, e.g. of seconds, a spatial resolution, e.g., of tenths of a mile, and a spatial scale, e.g., of miles.

The system can perform the electrical grid simulation in the selected simulation mode using the selected configuration of the electrical grid model. The system provides the output of the results of the electrical grid simulation, e.g., to a user interface of a computing device.

An electrical grid can undergo additions and changes on a continual basis. New buildings, renewable power plants, stationary storage, mobile storage, and expansions to existing buildings, facilities, and loads are some examples of potential changes that can be proposed and made to existing electrical systems, e.g., distribution feeders. As the electrical power grid becomes more complex and operating values approach critical limits, detailed prediction studies become more important and more complex. Detailed interconnection studies can be performed to document the operating characteristics of the existing power system, and also the predicted operation of the modified system. In this way, the impacts of the proposed interconnection can be fully evaluated before installation.

The simulation system can use a calibrated high resolution power grid model. The power grid model can include a model of the as-built grid, and can also include interconnections that have been approved but not yet built. The simulation system can use the power grid model to compare grid conditions prior to connection of the proposed interconnection to predicted grid conditions after connection of the proposed interconnection, in order to identify incremental effects of the interconnection.

In general, innovative aspects of the subject matter described in this specification can be embodied in methods that include the actions of obtaining a computer model of an electric power grid, simulating first behaviors of at least a region of the electric power grid according to the computer model using a first time resolution and a first modeling domain to determine a set of operational parameters for the region of the electric power grid, determining first values for the set of operational parameters at a first transition time point, converting the first values into a second, different modeling domain at the first transition time point to obtain converted first values, simulating second behaviors of at least the region of the electric power grid according to the computer model using a second time resolution and the second modeling domain to determine a second set of operational parameters, where the converted first values are initial conditions for simulating the second behaviors and the second time resolution is different from the first time resolution; and providing, as output, simulation results from at least one of the first behaviors and the second behaviors. Other implementations of this aspect include corresponding systems, apparatus, and computer programs, configured to perform the actions of the methods, encoded on computer storage devices.

These and other implementations can each optionally include one or more of the following features.

In some implementations, determining first values for the set of operational parameters at the first transition time point and converting the first values into the second modeling domain at the first transition time point to obtain converted first values are performed in response to detecting that a transient event will occur after but proximate to the first transition time point.

In some implementations, detecting that the transient event will occur includes determining that a transient event has been scheduled to occur during within a pre-determined time from the first transition time point.

In some implementations, detecting that the transient event will occur includes determining that simulated values of the set of operational parameters have triggered a transient event.

Some implementations include selecting the first transition time point as a time before the simulated values of the set of operational parameters triggered the transient.

Some implementations include: determining second values for the set of operational parameters at a second transition time point, converting the second values into the first modeling domain at the second transition time point to obtain converted second values, and continuing simulation of the first behaviors of the electric power grid based on the converted second values and according to the computer model using the first time resolution and the first modeling domain.

Some implementations include determining the second transition time point by determining that an electrical transient has settled.

In some implementations, determining that the electrical transient has settled includes determining that a magnitude value of at least one harmonic of the set of operational parameters is below a threshold settling value.

In some implementations, simulating the second behaviors includes simulating the second behaviors using multiple different time resolutions.

In some implementations, simulating the second behaviors includes selecting, from multiple different time resolutions, a particular time resolution that is relevant to simulating a particular type of electrical transient.

In some implementations, the particular time resolution is selected based on characteristics of the particular type of electrical transient.

Some implementations include, responsive to simulating the second behaviors, changing one or more operational parameters for at least one grid component in the computer model of the electric power grid.

In some implementations, at least one grid component in the computer model includes two or more sets of operating parameters or set points, each set being relevant to simulation in a different time resolution.

Some implementations include storing values for the first and second set of operational parameters at each time step simulated for the first behaviors and the second behaviors.

In some implementations, providing as output simulation results from the first behaviors and the second behaviors includes providing, for display, a user interface including an input that permits the user to view the first and second set of operational parameters at user selected time steps.

In some implementations, converting the first values into a second modeling domain at the first transition time point to obtain converted first values includes converting phasor domain values into time domain values.

In some implementations, converting the second values into the first modeling domain at the second transition time point to obtain converted second values includes converting time domain values into phasor domain values.

In some implementations, simulating the first behaviors is executed by a first processing thread and wherein simulating the second behaviors is executed by a second, different processing thread.

In some implementations, simulating the first behaviors is executed by a computing device and wherein simulating the second behaviors is executed by a second, different computing device.

In some implementations, converting the first values into the second modeling domain at the first transition time point to obtain converted first values includes: selecting, from among multiple conversion techniques, a particular conversion technique, and applying the particular conversion technique to convert the first values into the second modeling domain at the first transition time point and obtain converted first values.

In some implementations, the particular conversion technique is selected based on a type of an electrical transient to be simulated, one or more characteristics of electrical transient, a value of the second time resolution, or a combination thereof.

In some implementations, simulating first behaviors includes applying a powerflow simulation to the computer model.

Some implementations include: determining third values for the set of operational parameters at a third transition time point, converting the first values into a third, different modeling domain at the first transition time point to obtain converted second values, and simulating third behaviors of at least the region of the electric power grid according to the computer model using a third time resolution and the second modeling domain to determine a third set of operational parameters, wherein the converted second values are initial conditions for simulating the third behaviors and the third time resolution is different from the first time resolution and the second time resolution.

The subject matter described in this specification can be implemented in various embodiments and may result in one or more of the following technical advantages. For example, with the ability to switch between simulating steady-state and transient electrical behaviors, the simulation can provide more detail on highly complex transient events and their effect on the rest of the electrical grid, without demanding the computational load of always performing transient operations. In some implementations, the simulation engine can execute calculations on multiple threads and/or machines, so that calculations occur in parallel and/or in series, reducing an amount of time taken to simulate an electric grid.

Additionally, the simulation engine disclosed herein can decide when to transition between transient and steady state operations and the time resolution used in each simulation mode. In some implementations, the simulation engine can make decisions that a human might not think to make. For example, the simulation engine may identify a transition time point through machine learning that a human may overlook, and consequently transition in or out transient simulations in response to a trigger that a human may have considered.

The simulation system can model a full transmission and distribution system including electrical properties of grid components, active loads and generators with associated forecasted behavior, and centralized and distributed control. The grid models can enable simulations across any time scale of interest, e.g., from nanoseconds to years, and any geographical area of interest, e.g., from centimeters to thousands of kilometers.

Other implementations of the above aspects include corresponding systems, apparatus, and computer programs, configured to perform the actions of the methods, encoded on computer storage devices. The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example system for simulation of electrical power grids.

FIG. 2 illustrates an example process for simulation of electrical power grids.

FIGS. 3A and 3B illustrate example timelines as the simulation engine switches between different time resolution and simulation modes.

### DETAILED DESCRIPTION

In general, the present disclosure relates to a system for accurately simulating steady state and transient behavior of electrical power grids. Electrical power grids are interconnected networks of power sources, power loads, and power delivery and regulating components. Because of the inherent complexity of electric power grids, steady state and transient power grid behaviors are traditionally modeled separately. The present disclosure provides a process for integrating simulations of steady state and transient operations which accounts for the effects of transient events on the steady state operations and vice versa.

Briefly, the process simulates electric power grid operations in at least two layers: a steady state simulation layer and a transient simulation layer. Operations of an electric power grid are simulated in accordance with a computer model of the grid. The model electric grid can be simulated at different simulation layers. Each simulation layer simulates behaviors of the grid using a different representation of time (e.g., time-steady state vs. time-varying and/or using different size time steps) and may also employ different mathematical modeling domains. For example, in one implementation steady state behaviors are modeled with a simultaneous solution of net energy flow across a grid, often using iterative methods to converge on a steady-state solution. In other implementation, transient and dynamic behaviors of grid components and electrical systems are modeled as evolving over time, with a wide range of possible time steps (e.g. ranging from minutes to nanoseconds), and are solved using time-domain methods that produce time-series of electrical quantities such as voltage, current, real and reactive power, etc.

The simulation process transitions between steady state simulation and transient simulation when a transient event is detected. For example, the simulation transitions from simulating operations in the steady state layer to simulating operations in the transient layer when a transient event is inserted into the simulation by design (e.g., a lightning strike) or a transient event is triggered by the steady state operations (e.g., an electrical fault occurs). At the transition time point, operational parameters (e.g., power, current, voltage, phase, etc.) are converted from the steady state modeling domain (e.g., phasor) to the transient modeling domain (e.g., time domain) at each relevant electrical location in the power grid model. The transient simulation is executed using the converted values as initial conditions. The transient simulation is completed after the transient has settled. The simulation engine can determine the transient is settled, e.g., when the magnitude of high frequency harmonics for operational parameters fall below a threshold. Once the transient has settled relevant operational parameters are computed at relevant electrical locations in the power grid model and converted back to the steady state modeling domain. These values are used to continue the steady state simulation until the next transient occurs. In some implementations, the transient can cause operational parameters of grid assets (e.g., generators, transformers, breakers, switches, etc.) to change. In such cases, the post-transient operational parameters of affected grid assets are transferred between simulation layers during transitions between transient and steady state simulation.

In some implementations, the process can simulate electric power grid operations in multiple layers. For example, transient operations can be divided among multiple layers depending on the duration or frequency content of a transient and the timing resolution required to accurately model the transient.

In some implementations, electric grid assets may have different operating parameters or set points that are relevant for operations in steady state than for operations during transients. For example, a breaker may have a time delay overcurrent or overvoltage trip that trips the breaker only after a short period of time (fractions of a second). An electric grid model adapted to the combined steady state/transient simulation process can incorporate models for such components that indicate which operating parameters or set points for the component are effective (should be simulated) for each simulation layer. The simulation layers can then be configured to integrate component functionality according to the relevant operating parameters and/or set points.

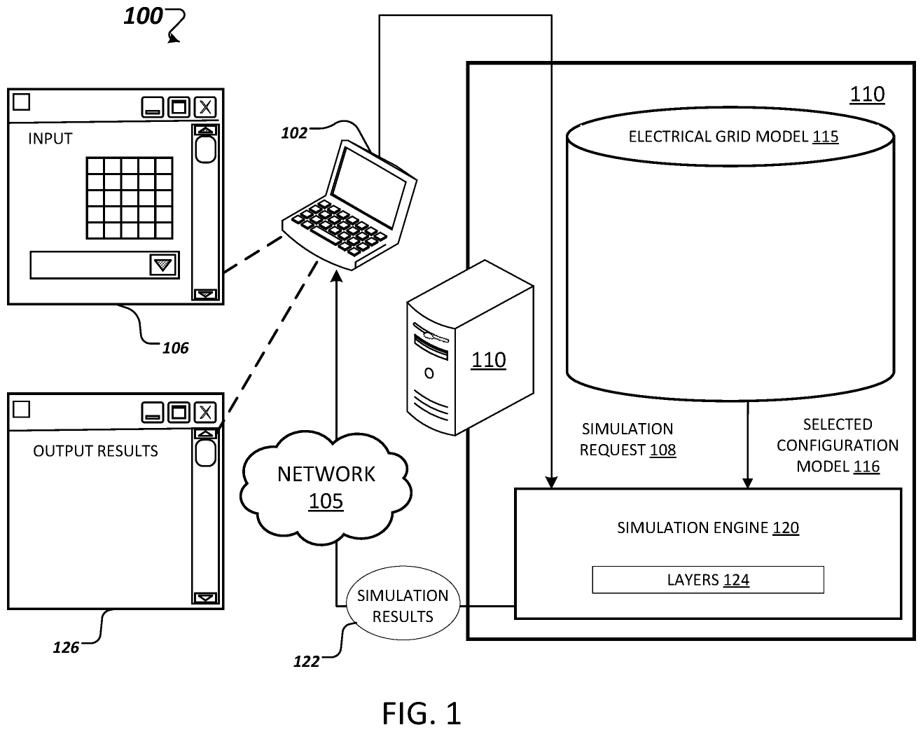

FIG. 1 is a diagram showing an example system 100 for simulation of electrical power grid operations. The system 100 includes a simulation server 110, which can simulate the power grid and provide simulation results 122 to a user device 102.

The simulation server 110 includes one or more data stores that store an electrical grid model 115 and a simulation engine 120. The simulation engine 120 can be provided as one or more computer executable software modules, hardware modules, or a combination thereof. For example, the simulation engine 120 can be implemented as blocks of software code with instructions that cause one or more processors of the simulation server 110 to execute operations described herein. In addition or alternatively, the simulation engine 120 can be implemented in electronic circuitry such as, e.g., programmable logic circuits, field programmable logic arrays (FPGA), or application specific integrated circuits (ASIC).

The simulation server 110 is a server system and can include one or more computing devices. In some implementations, the simulation server 110 may be part of a cloud computing platform. The simulation server 110 can be maintained and operated, for example, by an electrical grid operator such as an electrical power utility or a third party.

The user device 102 can communicate with the simulation server 110 over, for example, a network 105. The network 105 can include public and/or private networks and can include the Internet. The user device 102 can be an electronic device such as a computing device. The user device 102 can be, for example, a desktop computer, a laptop computer, a smart phone, a cell phone, a tablet, a PDA, etc.

The user device 102 can display both an input user interface 106 and an output user interface 126. The input user interface 106 can include an input form to enable a user to input a simulation request 108. In general, a user can provide a simulation request 108 to a simulation server 110 through an input user interface 106. The input user interface 106 includes input fields for various data. For example, the input user interface 106 includes an input field for a location, a change, a scenario, a data source, and requested output. In some examples, the input user interface 106 can include more or fewer input fields. The input user interface 106 can include input fields in various formats. For example, the input user interface 106 can include input fields with drop-down menus, slider icons, text input fields, maps, selectable icons, search fields, etc.

In some examples, the input location can include a center location for the simulation, e.g., a street address or latitude and longitude. The location can also include a radius for the simulation, e.g., in kilometers. In some examples, the location can include a zip code, town, city, or county. In some examples, the location can be input by the user through an interface that displays a map. For example, the user can select regions of a map for the simulation. In some examples, the user can draw boundaries for the simulation on a map.

In an example scenario, the user device 102 can send a simulation request 108 for simulation results 122 showing real-world electrical impacts of a rapid transient event on loads of an electrical feeder if a new solar panel system is connected to the grid. In this example, the input location can be a geographic radius centered at the location of the location of the added solar panel system. The input change can be the addition of the solar panel system. The input scenario can be the rapid transient event. The data source can be the best available aggregated data. The requested output can be a number of faults caused by the rapid transient event.

The user device 102 can send the simulation request 108 to the simulation server 110, e.g., over the network 105. The simulation request 108 includes the parameters input by the user, e.g., the location, scenario, change, data source, filters, and requested output.

In some implementations, the electrical grid model 115 is stored in a database that is accessible to the simulation server 110. The electrical grid model 115 can be a model of a real-world electrical power grid that transmits electrical power to loads such as residential and commercial buildings.

In some implementations, the electrical grid model 115 can include a high resolution electrical model of one or more electrical distribution feeders. The electrical grid model 115 can include, for example, data models of substation transformers, distribution switches and reclosers, voltage regulation schemes, e.g., tapped magnetics or switched capacitors, network transformers, load transformers, inverters, generators, and various loads. The electrical grid model 115 can include line models, e.g., electrical models of medium voltage distribution lines. The electrical grid model 115 can also include electrical models of fixed and switched line capacitors, as well as other grid components and equipment.

The electrical grid model 115 can include a topological representation of a power grid or a portion of the power grid. The detail of the electrical grid model 115 can be sufficient to allow for accurate simulation and representation of steady-state, dynamic and transient operation of the grid.

The electrical grid model 115 can include different versions of the same electrical grid. Each version may represent the past, the present and the future states of the grid, including changes of topology over time such as introduction of new assets and changing of switch positions. This enables analyzing past behavior as well as a series of planned or hypothetical scenarios. Different versions of the electrical grid model 115 can represent the intended grid design, the as-built design, the operational design, and future versions that represent combinations of planned and hypothetical equipment modifications, additions, removals, and replacements.

The electrical grid model 115 can adapt to differing levels of confidence, using machine learning to fill in gaps where model information is unknown or known with low confidence. For example, if provided connectivity data is insufficient, the model may augment automatically with connectivity information deduced from computer vision processing. For example, the electrical grid model 115 can include probabilistic models for the electrical properties of grid devices, power consumption, power generation, and asset failure based on estimated asset health.

The electrical grid model 115 can derive probabilistic information from historical and current versions of the electrical power grid. For example, to predict effects of a future modification of the electrical power grid, the electrical grid model 115 can analyze effects of previous similar modifications to the electrical power grid. The electrical grid model 115 can also incorporate and analyze historical data from electrical grids in various geographic locations. In this way, the electrical grid model 115 can use machine learning to identify trends and patterns in order to predict equipment performance in the future.

The electrical grid model 115 can be adaptive such that a change in one aspect of the electrical grid model 115 persists to all other aspects. For example, a new inverted-connected resource may be connected to the electrical power grid. The electrical grid model 115 can receive and incorporate data indicating the new resource.

The electrical grid model 115 can take into account the interdependency of energy systems beyond the electrical grid, such as the electrical elements of a natural gas storage, distribution and electrical generation system. The electrical grid model 115 can model interactions between the two systems. Backup power systems interacting with primary power systems is another example, particularly for battery and solar powered systems that may replace diesel generator systems. Detailed models of all interacting subsystems with associated simulations of all normal, abnormal and corner conditions can be performed.

The electrical grid model 115 can be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, possibly averaged over multiple years, or otherwise represented statistically.

In some examples, the electrical grid model 115 can include assumptions. For example, the electrical grid model 115 can include measured data for certain locations of the power grid, and might not include measured data for other locations. The electrical grid model 115 can use assumptions to interpolate grid operating data for locations in which measurements are not available. An assumption can be, for example, an assumed ratio or relationship between loads at industrial locations of the power grid compared to residential locations of the power grid.

In some examples, the electrical grid model 115 can include measured data for certain time intervals, e.g., certain hours, and might not include measured data for other time intervals. The electrical grid model 115 can use assumptions to estimate or interpolate grid operating data for time intervals in which measurements are not available. An assumption can be, for example, an assumed relationship between loads at a particular location at nighttime compared to daytime. In another example, an assumption can be an assumed relationship between loads at a particular location during an hour of the day in summertime, compared to during the same hour of the day in wintertime.

In some examples, the electrical grid model 115 can include measured data for certain characteristics, e.g., electrical load, and might not include measured data for other characteristics. The electrical grid model 115 can use assumptions to estimate grid operating data for characteristics for which measurements are not available. An assumption can be, for example, an assumed relationship between load and voltage at a particular location of the power grid.

In some examples, measured data can be used to resolve and reduce errors caused by assumptions in the electrical grid model 115. In some examples, the electrical grid model 115 can include conservative values in place of missing or incomplete data. In some examples, the electrical grid model 115 can use worst case assumptions to enable worst case analysis.

The simulation engine 120 can select a configuration model 116 of the electrical grid model 115, based on the simulation request 108. For example, a simulation request 108 may include a request for physical effects of a transient on the electrical grid in present day, modeled to the best available accuracy.

In some implementations, the simulation engine 120 includes a ruleset defining various combinations of user inputs for a simulation request 108 and appropriate configuration model 116 for each combination of user inputs. The simulation engine 120 can select the configuration model 116 for a given simulation request 108 by matching the inputs of the simulation request 108 with one of the input combinations defined in the ruleset. The simulation engine 120 would select the configuration model 116 associated with the particular rule of the ruleset that defines a similar combination of user inputs as those provided with the given simulation request 108.

The simulation engine can simulate simulation of steady state and transient electric grid operations and responses, collectively “behaviors”, on different layers 124. During operation, the simulation engine 120 can shift between different simulation modes or simulation layers 124. For example, the simulation engine 120 can simulate grid behaviors on at least two simulation layers: a steady state simulation layer and a transient simulation layer. Each simulation layer 124 simulates grid behaviors on a different time scale (e.g., different time step-size or time resolution), and in some case, may employ different mathematical modeling domains. For example, a steady state layer can model grid behaviors with a simultaneous solution of net energy flow across a grid to calculate various grid operational parameters (e.g., voltages and currents) at various locations throughout the grid for each time step. In some implementations, a steady state layer uses iterative methods to converge on a steady-state solution for the operational parameters. On the other hand, a transient simulation layer is used to simulate transient and dynamic behaviors of grid components and electrical systems as evolving over time. A transient simulation layer can include a wide range of possible time steps (e.g. ranging from minutes to nanoseconds) and calculate operational parameters using time-domain methods that produce time-series of electrical quantities such as voltage, current, real and reactive power, etc.

A steady state simulation layer simulates grid behaviors on a larger time scale than a transient simulation layer. For example, the steady state layer may simulate grid behaviors with a time scale on the order of several minutes or hours (e.g., a 5 minute step-size, a 30 minute step-size, or a 1 hour step size) whereas a transient simulation layer may simulate grid behaviors with a time scale on the order of seconds or smaller (e.g., step sizes ranging from seconds to nanoseconds).

The simulation engine 120 can shift between simulation layers 124 during the course of a simulation. For example, the simulation engine 120 can perform a simulation in a first simulation layer (e.g., a steady state layer) for a portion of a simulation, and a second simulation layer (e.g., a transient layer) for another portion of the simulation. The simulation engine 120 can transition between layers based on user input or dynamically, based on ongoing results of the simulation. For example, a user may provide input or indicate desired results from a particular layer at a particular time in the simulation. The user may provide input requesting to see transient level results at a particular time point in the simulation, and or for a particular duration of the simulation. In some implementations, the simulation engine 120 can permit users to insert various trigger events to cause a shift in the simulation layer. Trigger events can include, but are not limited to, lightning strikes, equipment protective actions (e.g., breaker trips), load demand surges, or a combination thereof. For example, a lightning strike at a particular location in the grid can trigger the simulation engine 120 to shift from a steady state layer to a transient layer in order to more accurately model the rapid behavioral fluctuations in the grid in response to the lightning strike.

Once a transient event is complete, the simulation engine 120 can shift the simulation back to steady state simulations. For example, the simulation engine 120 can simulate grid behaviors in the transient simulation layer for a defined period of time sufficient to capture the complete transient event. A defined period of time can be several seconds, or minutes, or another duration that allows the effects of the transient event to settle before the simulation engine 120 shifts back to the steady state simulation layer. In some implementations, the simulation engine 120 automatically shifts back to the steady state simulation layer after detecting, based on simulation results, that effects of the transient on electric grid behavior have settled. A transient event may be considered to settle when higher level harmonic oscillations in electric grid operational parameters (e.g., current and voltage) reduce below a threshold value.

In some implementations, simulating first behaviors is executed by a first processing thread, while simulating second behaviors is executed on the second, different processing thread. Similarly, the simulating first behaviors can be carried out on a first computing device, while simulating second behaviors can be carried out on the second, different computing device. In general, different layers 124 can be executed by different processing threads or on different machines.

In some implementations, electric grid assets within the grid model 115 may have different operating parameters or set points that are relevant for operations in steady state than for operations during transients. For example, a breaker may have a time delay over current or over voltage trip that trips the breaker only after a short period of time (fractions of a second). An electrical grid model 115 adapted to the combined steady state/transient simulation process can incorporate models for such components that indicate which operating parameters or set points for the component are effective (should be simulated) for each simulation layer. The simulation layers can then be configured to integrate component functionality according to the relevant operating parameters/set points.

The various grid components in the computer model can include two more sets of operating parameters or set points, each step being relevant to a simulation in a different time resolution. The computer model can have separate operating parameters for each component in the steady-state and transient domains. For example, a generator's control settings can change or are at least simulated differently on different time scales.

The simulation engine 120 can switch between models of subnetworks with different levels of detail depending on the subnetwork's electrical distance to the events being simulated. For example, the simulation engine 120 can simulate a distribution feeder connected to the transmission system as a single load, but then switch to a full feeder model when simulating a fault near its substation.

The simulation engine 120 can simulate the behavior of active, controllable devices on the grid including bulk power generation, transmission and distribution system controls, and distributed energy resources such as photovoltaic and battery systems.

The simulation engine 120 can simulate a distribution of voltage and current values by treating the simulation as a stochastic process. Each simulation step can sample from provided distributions of electrical properties, load, and generation. Running many of these simulations enables estimating a distribution over the outcomes and defining confidence intervals around the predicted behavior.

The simulation engine 120 can perform simulations based on the concept of Electro-Magnetic Transients but applied to every detail and every aspect of the combined electrical, mechanical, thermal, hydrocarbon-fuel subsystem. In an example, the simulation engine 120 can simulate a low-inertia, highly intermittent grid with a high proportion of electronic interfaces such as inverters between both sources and loads.

The simulated time period can be, for example, a simulated year. In some examples, the simulation engine 120 can generate simulated power grid data, or simulation results 122, for each hour of the simulated year. The simulation can include predicted loads and transients over the course of the simulated year based on historical data. For example, predicted loads may vary based on predicted seasonal effects (e.g., weather conditions) and calendar effects (e.g., weekends, holidays).

The location in the power grid can include a geographic location identified by the simulation request 108. For example, the location can include a postal address or a latitude and longitude coordinate position.

The simulation engine 120 can then perform a series of simulations. The simulations can be based on, for example, root-mean-square (RMS), power flow, positive sequence, and/or time series voltage transient analysis. The amount of data processed during each simulation can depend on the size and framework of the portion of the gird that is being evaluated. The simulation can analyze predicted effects for all connections to the affected distribution feeder and all components of the affected distribution feeder. Thus, the complexity of simulations can vary depending on construction of the distribution feeder.

For example, the simulations can vary depending on length, power, and number of loads of a distribution feeder. A typical distribution feeder can range in length from approximately one mile to ten miles. A typical distribution feeder can range in power from approximately one to ten megawatts. The number of loads connected to a feeder can range from a few hundred residential loads to several thousand residential loads. In some cases, there may also be as few as a few dozen commercial or industrial loads, and as many as hundreds of commercial or industrial loads. A similar situation may also arise with respect to transmission lines. For instance, the simulation may vary depending on length depending on the length, power, and number of power sources on a transmission network. Likewise, simulations, simulation parameters, and electric grid topologies may differ widely based on the location (e.g., urban vs rural and in different countries) of the electric grid being simulated.

The construction of a distribution feeder can also vary based on location. In urban environments, residential loads typically share transformers. In rural environments, each residential load may have a separate transformer. Three-phase transformers typically serve commercial and industrial loads. Thus, the number of loads and transformers in a feeder could be as low as a few hundred loads with a few hundred transformers for a rural feeder. The number of loads and transformers in a feeder could be as many as thousands of loads with hundreds of single-phase transformers in an urban environment, coupled with dozens or hundreds of larger three phase loads and transformers.

In some examples, the simulation engine 120 can simulate operation of multiple feeders. For example, simulations can include analyses of operation of all feeders across a geographic region, e.g., a city, county, province, or state. In some cases, the simulation engine 120 can model operation of each individual feeder within the region, and can aggregate the results in order to model operation of the multiple feeders of the region.

In some cases, the simulation engine 120 can model operational impacts of multiple feeders on each other. For example, multiple feeders may connect to a shared substation transformer. The simulation engine 120 can simulate the impacts of transients of one feeder on another feeder that is connected to the same transformer.

The simulation engine 120 can analyze the expected operation of the power grid by applying empirical historical data to the grid model. The empirical historical data can include historical electrical grid characteristics based on, for example, measurements, calculations, estimates, and interpolations. The characteristics can include, for example, load, voltage, current, and power factor. The empirical historical data can represent power grid operation of multiple interconnected components within a designated geographical area. The empirical historical data can represent average electrical grid operating characteristics over a period of time, e.g., multiple weeks, months, or years.

In some examples, the simulations can cover a range of operating conditions, particularly under extremes of voltage from the Bulk Power System (BPS) and extremes in load on the electrical distribution feeder. The simulation engine 120 can simulate corner cases of the system with the proposed interconnection added to the existing system. The simulations can also cover electrical grid conditions during steady-state operation and during transient operation. The simulation engine 120 can accurately simulate operations of loads and sources, aggregated loads and sources, and disaggregated loads and sources.

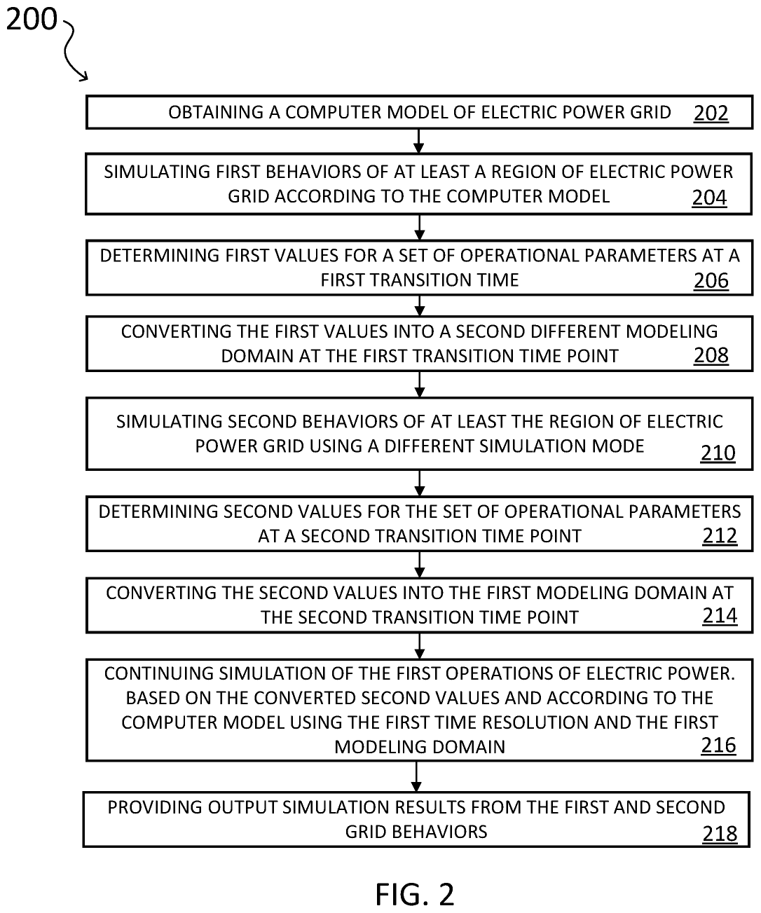

FIG. 2 illustrates an example process 200 for simulation of electrical power grids. Process 200 can be executed by one or more computing systems including, but not limited to, the simulation server 110 and simulation engine 120, described above, to simulate behaviors of an electric power grid based on an electrical grid model 115. Process 200 provides for combined simulation of steady state and transient electric grid operations and responses, collectively “behaviors,” to include responses to external stimuli (e.g., environmental stimuli). Process 200 provides for combined simulation of steady state and transient electric grid behaviors by shifting between two or more simulation modes in situ during one comprehensive simulation of an electric power grid. That is, for example, during the course of one simulation of the electric power grid for a particular simulation timeframe (e.g., user selected timeframe), the simulation engine 120 can shift between a steady state simulation mode and a transient simulation mode. Such shifts can be in response to events that occur within the simulation or based on user specified preferences for the simulation.

The simulation engine 120 can obtain a computer model of the electric power grid (202). For example, the simulation engine 120 can access an electric grid model 115 from a model database. In some implementations, electric grid model 115 can be a partial electric grid model or an electric grid model of a particular geographic region. In some implementations, the simulation engine 120 can receive an electric grid model 115 from a user. For example, the system 100 can permit a user to upload an electric grid model 115 or select a particular model for simulation from a model database.

The simulation engine 120 simulates first behaviors of the electric power grid according to the model (204). For example, the simulation engine 120 executes a simulation of the grid model 115 according to a first simulation mode. As discussed above, the simulation engine 120 can simulate electric grid behavior using different simulation layers 124. For instance, grid behaviors may initially be simulated according to a steady state simulation layer. The simulation engine 120 simulates the grid behaviors using a particular time step resolution, e.g., as indicated by the simulation layer 124 in use. The simulation engine 120 can simulate grid behaviors over a period of time. Calculated electric grid operational parameters can include, but are not limited to, current, voltage, and phase at various locations within the grid model. In some implementations, operational parameters can be calculated at each time step of the simulation.

The simulation engine 120 can simulate grid behaviors over a period of time using a mathematical domain that corresponds with steady state grid operations to calculate values for a set of electric grid operational parameters. For example, the simulation engine 120 can simulate steady state behaviors with a simultaneous solution of net energy flow across a grid. In some implementations, simulating first behaviors of the electric power grid can include applying a powerflow simulation to the computer model.

The simulation engine 120 determines first values for a set of operation parameters at a first transition time (206). For example, the simulation engine 120 simulates the behaviors of the electric grid and calculates values of current, voltage, and phase at one or more locations in the grid model at a transition time point.

The simulation engine 120 converts the first values into a different modeling domain at the transition time point (208). For example, converting the first values into a second modeling domain at the first transition time point to obtain converted first values can include converting between a mathematical domain used to simulate steady state behaviors and one used to simulate transient behavior. For example, operational parameters can be represented as phasor domain values for steady state behaviors and using time-domain representations (e.g., including multiple harmonics) for transient behaviors. Conversion between the values can include confirming between phasor and time-domain representations of current and voltage at multiple locations within the electric grid model 115.

In some implementations, steps 206 and 208 are performed in response to detecting that a transient event will occur after but proximate to the first transition time point. In some implementations, detecting that the transient event will occur includes determining that a transient event has been scheduled to occur within a predetermined time from the first transition time point.

In some implementations, detecting that the transient event will occur includes determining that simulated values of the set of operational parameters have triggered a transient. In such cases, the simulation engine can select the first transition time point as a time before the simulated values of the set of operational parameters triggered the transient.

The transition time point is a time, within the simulation, at which the simulation engine 120 will shift to simulating behaviors or all or part of the grid model using a different simulation layer 124. For example, a transition time point can be a predetermined point in time where a user has inserted a simulated transient event (e.g., a breaker trip, a lightning strike, loss of or addition of a major load or power source, etc.). In general, a transient event can be any event that causes short duration high frequency (e.g., greater than 50 Hz or 60 Hz) power fluctuations on the electric grid. As another example, a transient event may occur during the course of the simulation itself. For example, simulated values for operational parameters may exceed a protective set point for a grid asset, causing a transient event. The simulation engine 120 can detect such situations automatically by comparing grid parameter modeled grid asset set points (e.g., breaker trips). If such a set point is exceeded, the simulation engine 120 can mark the time of the trip as a transition time point for a transient event. In some implementations, the simulation engine 120 can mark the transition point as occurring slightly before (e.g., several seconds or milliseconds before) the protective set point was violated to ensure that the behaviors leading up to the protective action are properly modeled in a transient simulation layer.

The simulation engine 120 simulates second behaviors of the electric power grid according to the model using a different simulation mode (210). For example, the simulation engine 120 executes a simulation of the grid model 115 according to a second, different simulation mode. The simulation engine can take the converted first values from step 208 as initial conditions for simulating the second behaviors. For example, the simulation engine 120 may have shifted from simulating steady state behaviors to simulating transient behaviors. The simulation engine 120 then begins simulating transient behaviors, using a transient simulation layer. For example, the transient simulation layer can indicate a different time step resolution for the continued simulation and/or a different mathematical domain for performing the simulation. The grid behaviors are then simulated accordingly. In some implementations, the simulation engine 120 simulates second behaviors of the same region of the electric power grid simulated using the first simulation layer. In some implementations, the simulation engine 120 simulates second behaviors on a different region of the electric power grid. For example, a transient analysis can be performed on a smaller region of the grid model 115 such as a region that will be predominantly affected by the transient event. In some implementations, the simulation engine 120 can transition or shift into a different simulation layer, e.g., transient simulations, to simulate grid behaviors in only a portion of the electric grid model (e.g., in a particular geographic or electric region of the model), rather than simulating behavior of the entire electric grid model using the new simulation layer. For example, if a transient is triggered that would only impact a particular electrical region of the electric grid (e.g., a particular feeder), then the simulation engine 120 can transition to a transient simulation layer for simulating the behavior of that particular feeder while continuing to simulate the remainder of the electric grid model using a steady state simulation layer.

The simulation engine 120 determines second values for the set of operation parameters at a second transition time (212). For example, the simulation engine 120 simulates the behaviors of the electric grid and calculates values of current, voltage, and phase at one or more location in the grid model at a second transition time point. For example, if the second behaviors were transient behaviors, the simulation engine 120 determines the second transition time point by determining that the electrical transient has settled. In some implementations, the simulation engine 120 can determine that the electrical transient has settled based on higher frequency oscillations in values of the operational parameters. For example, the simulation engine 120 can determine that the transient has settled by determining that a magnitude value of at least one harmonic of the set of operational parameters is below a threshold settling value. For example, the simulation engine 120 can compare high frequency harmonics to expected steady state values of the respective harmonics. In some implementations, a transient event can be considered to have settled when the harmonics are below a predefined multiple of the respective steady state values (e.g., less than 200% of steady state values) to indicate that the harmonics will have minimal impact on steady state simulations.

The simulation engine 120 converts the second values into the first modeling domain at the second transition time point (214). For example, converting the second values into the first modeling domain at the second transition time point to obtain converted first values can include converting between a mathematical domain used to simulate transient behaviors and one used to simulate steady state behavior. In some implementations, converting the second values into the first modeling domain at the second transition time point to obtain converted second values can include converting time domain values into phasor domain values.

The simulation engine 120 simulates first behaviors of the electric power grid according to the model (216). For example, the simulation engine 120 continues simulations of the first behaviors, e. g., steady state operations. In some implementations, the continued simulation of the electric power grid is based on the converted second values. That is, the converted second values can be used as initial conditions to resume simulation of steady state operations. In some implementations, the simulation engine 120 continues simulation of the electric power grid behaviors according to the computer model using the first time resolution and the first modeling domain.

The simulation engine 120 provides output simulation results from the first and second behaviors (218). Based on the series of simulations, the simulation engine 120 outputs simulation results 122. The simulation results 122 can include time-varying electrical power grid characteristics at different locations of the electrical power grid for the simulated time period.

In some implementations, the process 200 can include additional steps, fewer steps, or some of the steps can be divided into multiple steps. For example, after step 218, the simulation engine 120 can change one or more operational parameters for at least one grid component in the computer model of the electric power grid. For example, the simulation engine 120 can change the operational parameters of a breaker if it tripped due to a transient.

In some implementations, at least one grid component (e.g., a breaker, generator, inverter, transformer, etc.) in the computer model can include two or more sets of operating parameters or set points, each set being relevant to simulation in a different time resolution. For example, an electric grid model 115 can include different component set points, operating parameters for transient simulation, e. g., groupings of parameters and/or breaker trip points. In some implementations, generator control settings can change, or the simulation engine 120 can simulate differently on different timescales.

The simulation engine 120 can store values for the first and second set of operational parameters at each time step simulated for the first and second behaviors.

In some implementations, the simulation engine 120 can provide simulation results 122 as output for display in a user interface 126. The user interface can permit the user to view the first and second set of operational parameters at user selected time steps. For example, the output user interface 126 can include a time zoom or panning functions to display values of electric grid operational parameters at different locations on the grid model. For example, a time panning function can cause values of electric grid operational parameters calculated at different time steps to be displayed. For example, the user interface can adjust displayed simulation output based on user input indicating a particular simulation time frame. The simulation server 110 can send the simulation results 122 to the user device 102 over the network 105.

In some implementations, the simulation server 110 can output the simulation results 122 to the user device 102. The user device 102 can display the simulation results 122 for viewing by a user, e.g., through an output user interface 126. In some implementations, the user can view the first and second set of operational parameters at selected time steps (e.g., a time zoom or panning function).

In some implementations, the user device 102 can display the simulation results 122 to a user through the output user interface 126. The output user interface 126 can display, for example, graphs, charts, and tables that indicate results of the simulation. In some examples, the output user interface 126 can display a visualization of the simulation results 122 in a two-dimensional and/or three-dimensional map view. The output user interface 126 can also display data including expected effects of proposed changes to the electrical grid. Expected effects can include costs, environmental effects such as changes in emissions, and changes in reliability of the electrical grid. The output user interface 126 can be interactive in order to enable a user to examine the results. For example, a user can select, e.g., using a computer mouse, an individual test, time period, or location, in order to view respective detailed simulation results 122.

The order of steps in the process 200 described above is illustrative only, and simulation of electrical power grids can be performed in different orders. For example, depending on if the simulation engine 120 executes on multiple threads or machines, certain steps can occur in parallel for certain regions of the electric grid. For example, a transient event might not effect an entire portion of the electric grid being modeled. In such an example, one machine could carry out steps 202-208 and skip steps 210-214 for the region of the electric grid unaffected by the transient event, while process 200 carries out as described for the area of the electric grid affected by the transient.

In some implementations, simulating the second behaviors can include using multiple, different time resolutions, e. g., multiple transient layers with different timescales. In some implementations, simulating the second behaviors can include selecting, from multiple different time resolutions, a particular time resolution that is relevant to simulating a particular type of electrical transient. In some implementations, the simulation engine 120 can select the particular time resolution based on characteristics of the particular type of electrical transient. For example, the appropriate timescale can depend on a type of transient or characteristics of the transient, such as a shorter/finer time resolution for lightning strike.

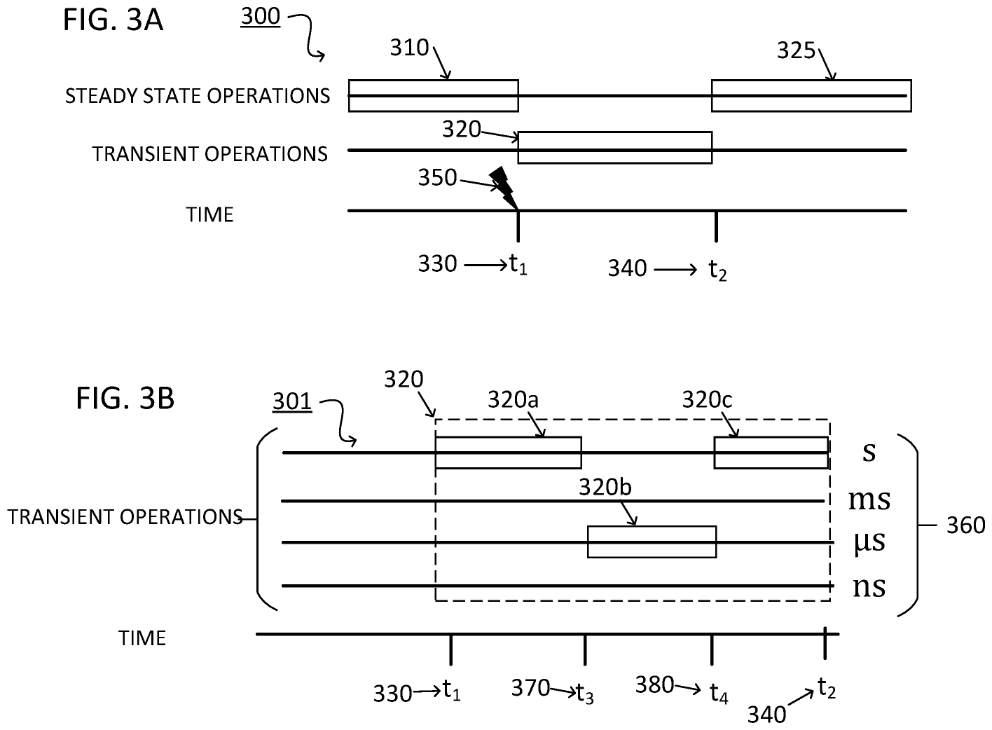

FIG. 3A illustrates a timeline 300 of the simulation switching between different time resolution and simulation modes, e. g., steady-state and transient layers, in response to a transient event. For example, the timeline 300 could take place between steps 204-216 of example process 200. During time period 310, the simulation engine 120 simulates steady state behaviors of the electric power grid according to the computer model 115. When a transient event 350, e. g. a lightning strike, is detected at a first transition time point 330, the simulation engine 120 shifts to a transient mode of simulation during time period 320. For example, as discussed above, the simulation engine 120 can determine the first values for the set of operational parameters (e.g., power, current, voltage, phase, etc.) at first transition time point 330. The transition time point 330 can occur substantially at the same time the event occurs or the transition time point 330 can be shifted slightly before the event to capture more detailed related to the event using the transient mode of simulation. Detection of a transient event 350 can occur due to a variety of reasons. For example, the system 100 can schedule a transient event 350 to occur within a predetermined time relative to the first transition time point 330. For example, the simulation engine 120 can model uncontrollable events, such as lightning strikes, to evaluate grid behaviors in response to such events. Such eventsss can be pre-inserted into the simulation at specific time points. In some implementations, the operational parameters can signal a transient event 350 while in the steady-state domain. In these implementations, the operational parameters can trigger a transient, and the simulation engine 120 can select the first transition time point 330 to occur before the operational parameters trigger the transient event 350.

Before switching to the transient simulation layer for time period 320, the simulation engine 120 can convert the first values into the transient modeling domain at the first transition time point to obtain converted first values, to be used in transient operations. The simulation engine 120 can use multiple conversion techniques, the type of transient to be simulated, one or more characteristics of the electrical transient, a value of the second time resolution, or combination thereof to determine the particular technique among the multiple. A signal processing layer can select between different techniques for converting data between layers 124. In some implementations, the simulation engine 120 converts the phasor domain values into time values, and vice versa.

The simulation engine 120 can simulate grid behaviors during time period 320 according to the computer model using a second time resolution in the second modeling domain to determine a second set of operational parameters. The converted first values can be initial conditions for simulating the second behaviors, and the second time resolution can be different from the first time resolution.

The simulation engine 120 may complete the transient simulation and revert to simulating steady state operations during time period 325 after the transient has settled. Once the transient has settled, the simulation engine 120 can compute the relevant operational parameters at relevant electrical locations in the electric grid model 115 and converted back to the steady state modeling domain. The simulation engine 120 uses these values to continue performing a steady state simulation during time period 325 until another transient event occurs. In some implementations, the transient event 350 can cause operational parameters of grid assets, e.g., generators, transformers, breakers, and/or switches, to change. In such cases, the simulation engine 120 transfers the post-transient operational parameters of affected grid assets between simulation layers during transitions between first and second behaviors 310 and 320.

A second transition time point 340 can occur after the transient event 350 has settled. At the second transition time point 340, the simulation engine 120 can determine the second values for the operational parameters according to the transient simulation. The simulation engine 120 can convert the second values into the first modeling domain, e. g., steady state simulation layer, at the second transition time point 340 which will be used to resume the steady state simulation after the transient event (e.g., time period 325).

The simulation engine 120 is adaptive and can take full advantage of the details provided by the electrical grid model 115. The simulation engine 120 can be capable of switching between different simulation modes based on the scales, resolutions, and models that are appropriate for the events being simulated. For example, the simulation engine 120 can simulate steady state power flow before and after a capacitor switching event, and model the capacitor switching event itself in the time domain to analyze the electromagnetic transients.

In some implementations, the simulation engine 120 includes more than two simulation layers 124. For example, as shown in the timeline 301 depicted in FIG. 3B, the simulation engine 120 can include multiple transient layers, each used for simulating grid operations at an increasingly detailed level of resolution. In such implementations, the simulation engine 120 can shift into from a first transient layer, in which grid behaviors are modeled using a first time resolution (e.g., 1 second time steps), and shift into another transient layer, in which grid behaviors are model using a finer time resolution (e.g., 1 ms time steps). The process of shifting between more detailed transient simulation modes is similar to the operations discussed above in reference to process 200. For example, the simulation engine 120 can convert the grid parameter values from the 1 second resolution layer into corresponding values for use in the 1 ms resolution layer, at the appropriate transition time point. The simulation engine 120 the proceeds to simulate grid behaviors according to the time scale resolution and mathematical domain defined by the new simulation layer (e.g., a sub-transient simulation layer) until the transient settles sufficiently to shift back to steady state or to a lower resolution transient simulation layer. For example, transient simulations may trigger transients that require higher time resolution to adequately simulate grid behavior, such as derived or contingent transient events. For example, one transient event may cause additional transient events that need to be analyzed at higher time resolutions.

FIG. 3B illustrates a timeline 301 of the simulation switching between different time resolution and simulation modes, e. g., different transient layers. In some implementations, multiple layers 360 within the transient modeling domain are used to simulate the electric grid behaviors at varying levels of time resolution. For example, transient operations can be divided among multiple layers 360 depending on characteristics including, but not limited to, the duration or expected duration of a transient, the frequency content or expected frequency content of a transient, the type of a transient, the timing resolution required to accurately model the transient, or a combination thereof. For example, depending on the type of transient event 350 that occurs, different time resolutions are more appropriate, based on characteristics of the particular type of electrical transient (e. g., use shorter/finer time resolution for a lightning strike).

FIG. 3B shows a more detailed view of simulation mode shifting that may occur in implementations of the present disclosure that include multiple transient simulation layers during the transient simulation performed for timer period 320. In other words, FIG. 3B represents a more detailed view of time period 320 for such implementations. For example, immediately after an electrical fault occurs at a transition time point 330, the simulation engine shifts to the second timescale transient simulation layer to simulate grid behavior during time period 320a. As the transient progresses, a higher resolution timescale might be required to capture the operational parameters more accurately. For example, the transient response during time period 320a triggers a subsequent transient at (or around) transition time point 370. If the newly triggered transient event requires a higher resolution simulation, the simulation engine 120 shifts to the microsecond simulation layer at transition time t3.

The simulation continues by employing the microsecond simulation layer for time period 320b. As the transient(s) begins to settle, a lower resolution timescale is able to capture the operational parameters just as accurately, and decreasing the timescale resolution may require less computational power. At a fourth transition time point 380, the simulation engine 120 can switch the time resolution from the microsecond transient simulation layer back to the seconds transient simulation layer. At transition time point 340 the transient(s) settle and the simulation engine 120 shifts back to steady state simulation mode, as depicted in FIG. 3A.

In some implementations, specific simulation layers 124 can be selected to simulate particular types of transients. For example, some transients may occur faster than others, therefore, requiring a higher resolution simulation. In such implementations, the simulation engine 120 can select the appropriate transient simulation layer for simulating a transient event based on the type of transient event. For example, the simulation engine 120 can employ a lookup table that associates various types of transient events with a corresponding simulation layer and/or time step resolution to the user for simulating the transient.

In some implementations, the transient modeling is limited to a smaller geographic region than the selected geographic region, while steady state modeling is used in the rest of the selected geographic region. The simulation engine 120 and stitch the results of each region together when compiling simulation results 122.

In some implementations, converting the first values into a second values include selecting a conversion technique for performing the conversion, and applying the selected conversion technique to convert the first values into the second modeling domain. In some implementations, the particular conversion technique is selected based on a type of an electrical transient to be simulated, one or more characteristics of electrical transient, a value of the second time resolution, or a combination thereof. For example, the simulation engine 120 can include a signal processing layer to select between different techniques for converting data between layers 124. Converting from a steady state layer to a transient layer can include converting phasors to time domain and initializing state variables. Converting from a transient layer to a steady state layer can include using Fourier transforms to extract relevant frequency and phasor values.

This disclosure generally describes computer-implemented methods, software, and systems for electrical power grid visualization. A computing system can receive various electrical power grid data from multiple sources. Power grid data can include different temporal and spatially dependent characteristics of a power grid. The characteristics can include, for example, power flow, voltage, power factor, feeder utilization, and transformer utilization. These characteristics can be coupled; for example, some characteristics may influence others and/or their temporal and spatial dependence may be related.

Data sources can include satellites, aerial image databases, publicly available government power grid databases, and utility provider databases. The sources can also include sensors installed within the electrical grid by the grid operator or by others, e.g., power meters, current meters, voltage meters, or other devices with sensing capabilities that are connected to the power grid. Data sources can include databases and sensors for both high voltage transmission and medium voltage distribution and low voltage utilization systems.

The data can include, but is not limited to, map data, transformer locations and capacities, feeder locations and capacities, load locations, or a combination thereof. The data can also include measured data from various points of the electrical grid, e.g., voltage, power, current, power factor, phase, and phase balance between lines. In some examples, the data can include historical measured power grid data. In some examples, the data can include real-time measured power grid data. In some examples, the data can include simulated data. In some examples, the data can include a combination of measured and simulated data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any system or on the scope of what may be claimed, but rather as descriptions of features that may be specific to particular implementations of particular systems. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. An electric power grid simulation method comprising:
obtaining a computer model of an electric power grid;
simulating first behaviors of at least a region of the electric power grid according to the computer model using a first time resolution and a first modeling domain to determine a set of operational parameters for the region of the electric power grid;
determining first values for the set of operational parameters at a first transition time point;
converting the first values into a second, different modeling domain at the first transition time point to obtain converted first values;
simulating second behaviors of at least the region of the electric power grid according to the computer model using a second time resolution and the second modeling domain to determine a second set of operational parameters, wherein the converted first values are initial conditions for simulating the second behaviors and the second time resolution is different from the first time resolution; and
providing, as output, simulation results from at least one of the first behaviors and the second behaviors.

2. The method of claim 1, wherein determining first values for the set of operational parameters at the first transition time point and converting the first values into the second modeling domain at the first transition time point to obtain converted first values are performed in response to detecting that a transient event will occur after but proximate to the first transition time point.

3. The method of claim 2, wherein detecting that the transient event will occur comprises determining that a transient event has been scheduled to occur during within a pre-determined time from the first transition time point.

4. The method of claim 2, wherein detecting that the transient event will occur comprises determining that simulated values of the set of operational parameters have triggered a transient event.

5. The method of claim 4, further comprising selecting the first transition time point as a time before the simulated values of the set of operational parameters triggered the transient.

6. The method of claim 1, further comprising:
determining second values for the set of operational parameters at a second transition time point;
converting the second values into the first modeling domain at the second transition time point to obtain converted second values; and
continuing simulation of the first behaviors of the electric power grid based on the converted second values and according to the computer model using the first time resolution and the first modeling domain.

7. The method of claim 6, further comprising determining the second transition time point by determining that an electrical transient has settled.

8. The method of claim 7, wherein determining that the electrical transient has settled comprises determining that a magnitude value of at least one harmonic of the set of operational parameters is below a threshold settling value.

9. The method of claim 1, wherein simulating the second behaviors comprises simulating the second behaviors using multiple different time resolutions.

10. The method of claim 9, wherein simulating the second behaviors comprises selecting, from multiple different time resolutions, a particular time resolution that is relevant to simulating a particular type of electrical transient.

11. The method of claim 10, wherein the particular time resolution is selected based on characteristics of the particular type of electrical transient.

12. The method of claim 1, further comprising, responsive to simulating the second behaviors, changing one or more operational parameters for at least one grid component in the computer model of the electric power grid.

13. The method of claim 1, wherein at least one grid component in the computer model includes two or more sets of operating parameters or set points, each set being relevant to simulation in a different time resolution.

14. The method of claim 1, further comprising storing values for the first and second set of operational parameters at each time step simulated for the first behaviors and the second behaviors.

15. The method of claim 14, wherein providing as output simulation results from the first behaviors and the second behaviors comprises providing, for display, a user interface comprising an input that permits the user to view the first and second set of operational parameters at user selected time steps.

16. The method of claim 1, wherein converting the first values into a second modeling domain at the first transition time point to obtain converted first values comprises converting phasor domain values into time domain values.

17. The method of claim 6, wherein converting the second values into the first modeling domain at the second transition time point to obtain converted second values comprises converting time domain values into phasor domain values.

18. The method of claim 1, wherein simulating the first behaviors is executed by a first processing thread and wherein simulating the second behaviors is executed by a second, different processing thread.

19. The method of claim 1, wherein simulating the first behaviors is executed by a computing device and wherein simulating the second behaviors is executed by a second, different computing device.

20. The method of claim 1, wherein converting the first values into the second modeling domain at the first transition time point to obtain converted first values comprises:
selecting, from among multiple conversion techniques, a particular conversion technique; and
applying the particular conversion technique to convert the first values into the second modeling domain at the first transition time point and obtain converted first values.

21. The method of claim 20, wherein the particular conversion technique is selected based on a type of an electrical transient to be simulated, one or more characteristics of electrical transient, a value of the second time resolution, or a combination thereof.

22. The method of claim 1, wherein simulating first behaviors comprises applying a powerflow simulation to the computer model.

23. The method of claim 1, further comprising:
determining third values for the set of operational parameters at a third transition time point;
converting the first values into a third, different modeling domain at the first transition time point to obtain converted second values; and
simulating third behaviors of at least the region of the electric power grid according to the computer model using a third time resolution and the second modeling domain to determine a third set of operational parameters, wherein the converted second values are initial conditions for simulating the third behaviors and the third time resolution is different from the first time resolution and the second time resolution.

24. A system comprising:
at least one processor; and a data store coupled to the at least one processor having instructions stored thereon which, when executed by the at least one processor, causes the at least one processor to perform operations comprising:
obtaining a computer model of an electric power grid;
simulating first behaviors of at least a region of the electric power grid according to the computer model using a first time resolution and a first modeling domain to determine a set of operational parameters for the region of the electric power grid;
determining first values for the set of operational parameters at a first transition time point;
converting the first values into a second, different modeling domain at the first transition time point to obtain converted first values;
simulating second behaviors of at least the region of the electric power grid according to the computer model using a second time resolution and the second modeling domain to determine a second set of operational parameters, wherein the converted first values are initial conditions for simulating the second behaviors and the second time resolution is different from the first time resolution; and
providing, as output, simulation results from at least one of the first behaviors and the second behaviors.

25. A non-transitory computer readable storage medium storing instructions that, when executed by at least one processor, cause the at least one processor to perform operations comprising:
obtaining a computer model of an electric power grid;
simulating first behaviors of at least a region of the electric power grid according to the computer model using a first time resolution and a first modeling domain to determine a set of operational parameters for the region of the electric power grid;
determining first values for the set of operational parameters at a first transition time point;
converting the first values into a second, different modeling domain at the first transition time point to obtain converted first values;
simulating second behaviors of at least the region of the electric power grid according to the computer model using a second time resolution and the second modeling domain to determine a second set of operational parameters, wherein the converted first values are initial conditions for simulating the second behaviors and the second time resolution is different from the first time resolution; and
providing, as output, simulation results from at least one of the first behaviors and the second behaviors.
